(19) United States
(12) Patent Application Publication
(10) Pub. No.: US 2004/0162690 A1
(43) Pub. Date: Aug. 19, 2004

(54) Method and system for analyzing test devices

(76) Inventor: Jin Po Lee, Carlsbad, CA (US)

Correspondence Address: MORRISON & FOERSTER LLP, 3811 VALLEY CENTRE DRIVE, SUITE 500, SAN DIEGO, CA, 92130-2332, US

(21) Appl. No.: 10/701,717

(22) Filed: Nov. 4, 2003

Related U.S. Application Data
(60) Provisional application No. 60/427,779, filed on Nov. 19, 2002.

(51) Int. Cl. G06F 19/00

(52) U.S. Cl. 702/105; 382/121; 702/19

(57) ABSTRACT

A method and system for automatically and optically analyzing one or more test devices using a digital scanner coupled to a computer. In one embodiment, the method and system utilizes a template for use in conjunction with the scanner wherein one or more test devices are received and held within respective windows in the template. In this way, the template prevents any significant movement of the test devices in the scanning device during scanning, thereby allowing an accurate scan of the color indicators of each test device. In a further embodiment, the windows of the template define target areas for analysis by imaging software that analyzes the digital images of the test devices.

### CROSS-REFERENCE TO RELATED APPLICATIONS

The present application claims the benefit of priority under 35 U.S.C. § 119(e) to U.S. Provisional Patent Application Serial No. 60/427,779 entitled “METHOD AND SYSTEM FOR ANALYZING TEST DEVICES,” filed on Nov. 19, 2002, the entirety of which is incorporated by reference herein.

### BACKGROUND OF THE INVENTION

1. Field of the Invention

The present invention relates to an improved method and system for optically analyzing immunoassay test devices such as test strips used for measuring the concentration levels of one or more substances in a liquid (e.g., blood, urine or saliva). In particular, the invention relates to a method and system for analyzing one or more test devices by utilizing a digital scanning device in conjunction with a computer.

2. Description of the Related Art

Existing optical measuring systems for analyzing test devices are extremely complex and expensive. This is because they have highly sophisticated imaging systems that require careful calibration and maintenance to provide consistently reliable results. Many organizations, such as police departments, that conduct tests on the concentration levels of illicit drugs and/or alcohol in blood, urine or saliva, for example, cannot afford these existing optical measuring systems due to their cost and complexity. Today, law enforcement personnel perform the analysis of test results manually by visually inspecting the test devices for a color indication of the concentration of a given substance. The color indication is typically a color intensity, color frequency (e.g., red, green or blue) or the ratio of color intensities between a control line/area and a test line/area. The test devices may also each contain multiple color indicators, such as multiple test lines, corresponding to different tests or different test subjects. These and other types of test devices are well-known in the art and need not be explained in further detail herein. After a test fluid (e.g., saliva) is placed onto the test device, a police officer inspects the test device for a color indication and makes a human judgment as to what the test results indicate. The officer then typically writes a report based on his or her visual assessment of the color indication.

As one might imagine, the above-described manual inspection process is extremely susceptible to human error and inefficient when many test devices need to be analyzed in a short period of time. This deficiency in the existing manual/visual inspection methods pose an even greater disadvantage in the context of law enforcement because the reports prepared by the officers must be reliable and accurate to serve as useful evidence. Thus, there is a need for an improved method and system for conducting an automated optical analysis of test devices that is reliable, efficient and cost-effective.

### SUMMARY OF THE INVENTION

The present invention addresses the above and other needs by providing a method and system of automatically and optically analyzing one or more test devices using a digital scanner and a computer.

In one preferred embodiment, the invention utilizes a template for use in conjunction with the scanner wherein one or more test devices are received and held within respective windows in the template. In this way, the template prevents any significant movement of the test devices in the scanning device during scanning, thereby allowing an accurate scan of the color indicators of each test device.

In a further embodiment, the edges of the windows within the template function as boundaries of a test area that is recognized by imaging software executed by the computer, which is coupled to the scanning device.

In another embodiment, the scanning device is an off-the-shelf standard digital scanner that is generally used for scanning documents and the computer is a standard personal computer.

In a further embodiment, each test device has placed thereon a bar code, which can contain various types of information. During the scanning process, in addition to scanning the color indicators, the scanner scans the bar code of each test device for information pertinent to that device. This pertinent information may identify a person that supplied the test fluid being tested and/or contain information pertaining to the color indicator(s) (e.g., color intensity of control line), or any other information desired by the test device designer and/or manufacturer.

In a further embodiment, after scanning the one or more test devices, a test report is automatically generated by the software executed by the computer. This report may illustrate the results in any desired format and may include graphics illustrating one or more values of interest.

### BRIEF DESCRIPTION OF THE DRAWINGS

FIG. 1 illustrates a system for optically analyzing one or more test devices, in accordance with one embodiment of the invention.

FIGS. 2A and 2B illustrate exemplary templates that may be used in the system of FIG. 1, in accordance with preferred embodiments of the invention.

FIG. 3A illustrates an exemplary test device that may be analyzed in accordance with the present invention.

FIGS. 3B and 3C illustrate exemplary test reports generated as a result of analyzing the test device of FIG. 3A, in accordance with one embodiment of the invention.

FIG. 4 illustrates a saliva screening device that may be used in conjunction with the system of FIG. 1, in accordance with one embodiment of the invention.

FIG. 5 illustrates how saliva may be collected from a human test subject using the saliva screening device of FIG. 4, in accordance with one embodiment of the invention.

FIG. 6 illustrates how saliva may be dispensed onto a test device using the saliva screening device of FIG. 4, in accordance with one embodiment of the invention.

### DETAILED DESCRIPTION OF THE PREFERRED EMBODIMENTS

The invention is described in detail below with reference to the figures, wherein like elements are referenced with like numerals throughout.

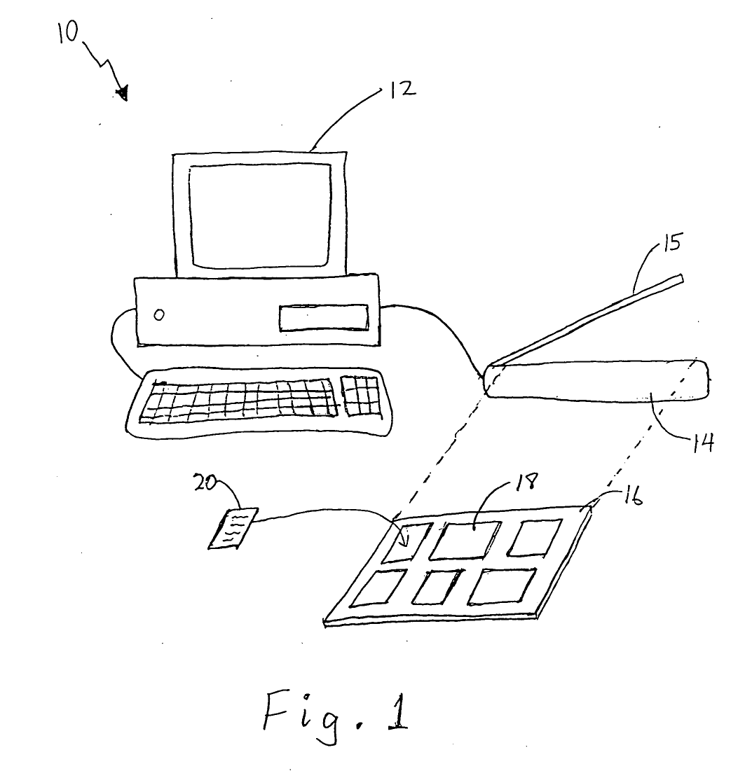

Referring to FIG. 1, in one embodiment of the present invention, a system 10 includes a standard computer 12 and a standard scanner 14, coupled to the computer 12. In one embodiment, the computer 12 is a Compaq Presario 1500 Notebook computer with a Pentium IV™ processor and the scanner 14 is a UMAX scanner. However, it is understood that other computer and scanner models and/or brands may be used in accordance with the present invention. The system 10 further includes a template 16 that is placed onto the scanning surface of the scanner 14 during scanning. The template 16 includes one or more windows 18 cut into the template 16 for holding a respective test device 20, which has a size and shape that allows it to snugly fit into the window 18.

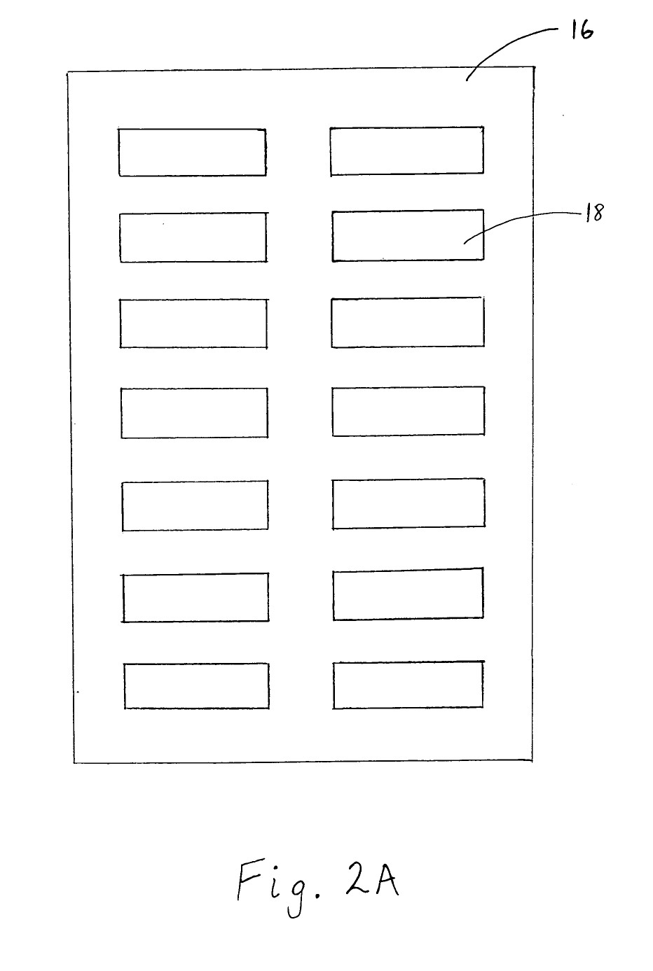

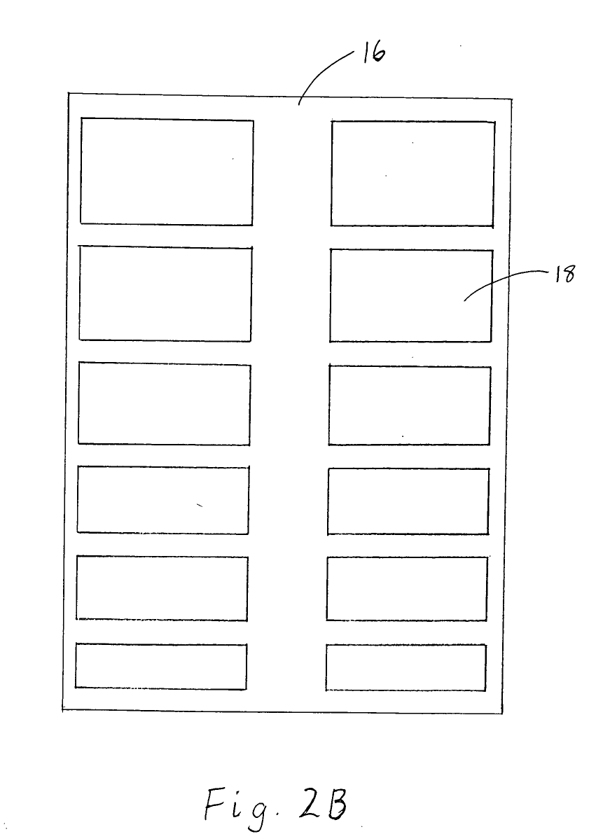

FIGS. 2A and 2B illustrate two exemplary templates 16 each including a plurality of windows 18 for receiving and holding correspondingly configured test devices 20 (FIG. 1). The template 16 may be made from any one of a number of materials such as aluminum, iron (copper), plastic, or any combination of materials providing suitable rigidity for securely holding one or more test devices 20. The dimensions (height, width, thickness) of the template 16 and windows 18 should also be within specified tolerances so as to snugly fit on the surface of the scanning device 14 in order to minimize movement and vibration of the template 16, and test devices 20 contained therein, during the scanning process. In a preferred embodiment, when a lid 15 (FIG. 1) of the scanner 14 (FIG. 1) is placed in the downward, scanning position, the thickness of the template 16 should be such that the lid may be substantially closed in its full downward, scanning position. In one embodiment, the thickness of the template is between 0.5 to 1.5 millimeters. Additionally, in one embodiment, the length and width of the template 16 is configured to fit on top of a transparent scanning surface of the scanner 14 such that at least one corner of the template 16 may be aligned with one corner of the scanning surface. In this way, lateral movement of the template 16 during scanning may be minimized. Thus, when correspondingly configured test devices 20 are placed into respective windows 18, the template 16 allows the test devices 20 to remain in a fixed position within the target areas during scanning of the test devices 20.

Defining target areas for analysis allows imaging software to focus on those areas in the digital images generated by the scanner and treat other areas as background areas. In this way, the imaging software can more efficiently process the visual data that is present in the target areas and ignore irrelevant background data. In one embodiment, the target areas are defined by the boundary edges of the windows 18 and recognized by the scanning software during scanning. In various embodiments, the template 16 may be of different colors, or combinations of colors, to assist in optical analysis. Additionally, the windows 18 may be cut in different shapes and sizes to conform to various types of test devices 20.

In one embodiment, the scanner 14 first scans the template 16 alone, without any test devices 20 contained therein, to generate a digital image of the template 16. By analyzing this digital image, imaging software executed by the computer 12 can then identify and define the windows 18 as target areas for subsequent scans. Those of ordinary skill in art can readily develop imaging software to analyze the digital image of the template 16 and determine the spatial coordinates (e.g., 2-dimensional x-y coordinates) of the boundaries of the target areas corresponding to the boundary edges of the windows 18, using known imaging techniques. After the target area boundaries have been defined, the test devices 20 are inserted into respective windows 18 and scanned to obtain an image of the test devices 20 that are now in the position of the defined target areas. Once each test device 20 is scanned, the resulting image may be analyzed to determine or extract desired information based on the characteristics of the image (e.g., color lines, patterns, etc.).

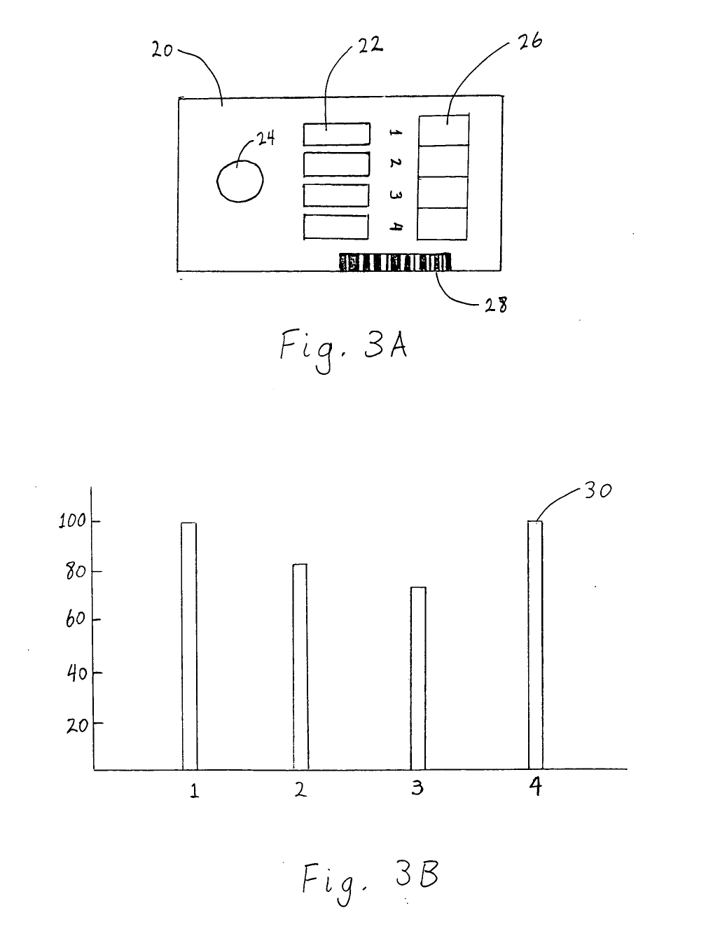

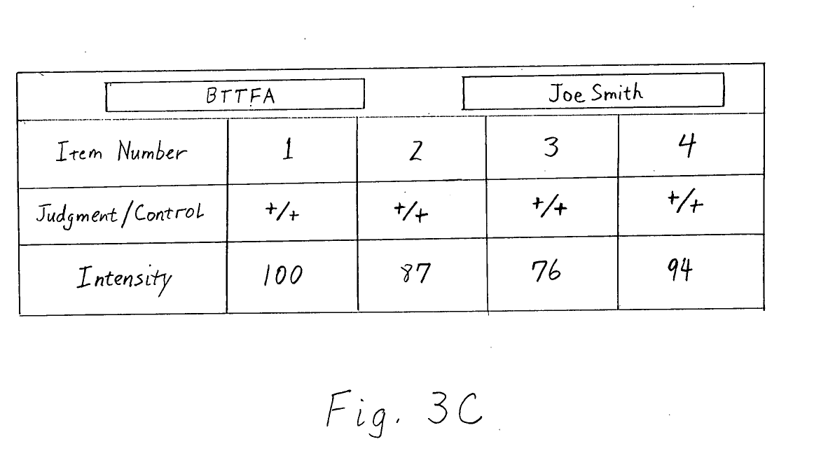

FIG. 3A illustrates an exemplary image of a test device that may be scanned in one of the test areas. Although the image is in black and white in FIG. 3A, the actual image of the particular test device shown may be in color with appropriate color indicators (e.g., color test lines and/or control lines). However, black and white images can also be analyzed by the method and system of the present invention as well. When analyzing black and white images, the scanning software would detect patterns or other indicators of information, other than color.

In the exemplary test device of FIG. 3A, there are four test lines or zones 22 each exhibiting a respective color or color intensity that is indicative of a particular value (e.g., concentration level of a particular substance) associated with a substance being tested. A sample of the substance being tested (e.g., saliva) is placed in a sample well 24 also located on the test device 20. After the test substance is placed in the sample well 24, the test device 20 can indicate the presence or absence of one or more compounds or substances in the test substance. For example, in one embodiment, the test device 20 incorporates a competitive binding immunoassay in which drug and drug metabolites in a saliva sample compete with immobilized drug conjugate for limited labeled antibody binding sites. By utilizing antibodies that are specific to different drug classes, the test permits independent, simultaneous detection of multiple drugs from a single saliva sample.

In one embodiment, in the assay procedure, the saliva mixes with labeled antibody-dye conjugate and migrates along a porous membrane. When the concentration of a given drug is below the detection limit of the test, unbound antibody-dye conjugate binds to antigen conjugate immobilized on the membrane, producing color band (e.g., a rose-pink color band) in the appropriate test zone 22 for that drug. Conversely, when the drug level is at or above the detection limit, free drug competes with the immobilized antigen conjugate on the membrane by binding to antibody-dye conjugate, forming an antigen-antibody complex and preventing the development of a color band.

As shown in FIG. 3A, the test device 20 further includes one or more control lines or zones 26 wherein a color band is produced in each control zone 26 by a parallel immunoassay reaction. These “control” color bands serve as a quality control measure by demonstrating antibody recognition, verifying that the reagents in the test device 20 are chemically active. Therefore, if a color band is not produced in a particular test zone 22, it is most likely due to the presence of competing drug metabolites in the test sample rather an inactive reagent in the test device 20.

In a further embodiment, the test device 20 includes a bar code 28. This bar code may contain information pertaining to the test subject, the substance being tested by each test line, and/or information pertaining to control parameters/values for one or more of the test lines. It is apparent that various types of information may be contained in the bar code as desired by the test designer.

Imaging software for identifying and analyzing color intensities, color frequencies, color ratios, geometric patterns, boundary lines, etc., are well known in the art. Various types of imaging software for reading bar codes are also well-known in the art. In one embodiment, after the scanner 14 scans the test device 20 of FIG. 3A, scanning software analyzes and processes the data provided by the digital image generated by the scanner 14 and then generates an exemplary report as shown in FIG. 3B. For example, the digital image may show a certain visual indicator or characteristic (e.g., color, color intensity, pattern, etc.) in each of the respective test zones which may indicate the presence or absence of a respective chemical in the substance being tested. As shown in FIG. 3B, each test zone result is represented by a graphic bar symbol 30 having a height that is indicative of a value of interest (e.g., concentration level of a respective chemical).

FIG. 3C illustrates another exemplary format for illustrating the test results obtained by analyzing the image of the test device 20. As shown in FIG. 3C, item numbers 1-4 correspond to respective test zones 22 designed to screen for particular substances (e.g., opiates/morphine, marijuana, cocaine, methamphetamine) in a test substance (e.g., saliva), a “judgment/control” parameter set is provided for each test line (e.g., +/+), and an concentration/intensity value is provided for each test line. The judgment parameter indicates whether the test results are positive (i.e., present) or negative (i.e., not present) for a particular substance (e.g., cocaine) being screened. The control parameter indicates whether the reagent used for detecting the presence of the particular substance is active (+) or inactive (−). If the reagent is inactive, resulting in a negative control parameter, then the test result is invalid for that particular substance.

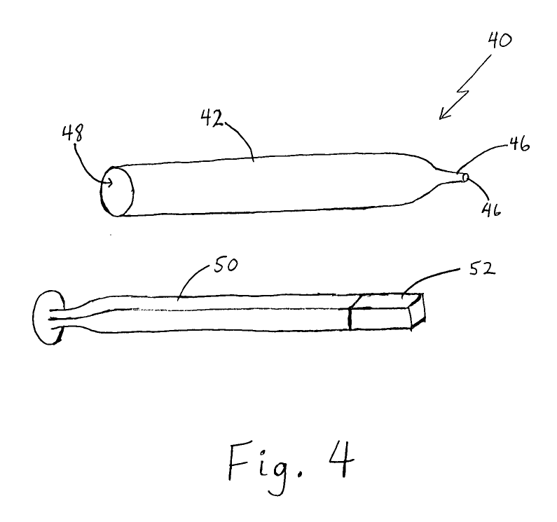

FIG. 4 illustrates a saliva screening device 40 that may be used in conjunction with the system 10 of FIG. 1, in accordance with one embodiment of the invention. The saliva screening device 40 includes a syringe tube 42 having a tapered end 44 with a dispensing hole 46 at the tip of the tapered end 44. The tube 42 further includes an opening 48 located at the end opposite to the tapered end 44. The opening 48 is configured to receive a syringe plunger 50, which includes a foam or sponge liquid absorber 52 attached at one end of the syringe plunger 50.

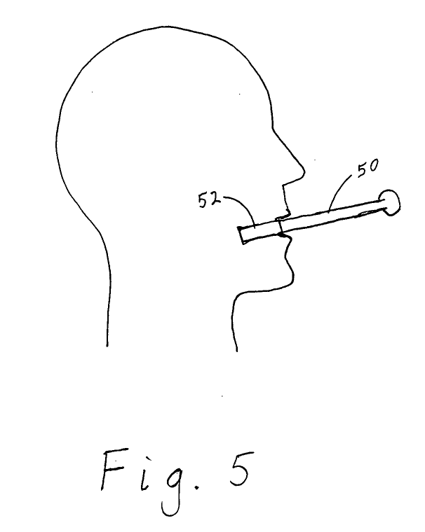

FIG. 5 illustrates one method of obtaining a saliva sample from a human test subject using the syringe plunger 50. As shown in FIG. 5, the syringe plunger 50 is inserted into the mouth of the test subject such that the foam or sponge absorber 52 is placed into the mouth of the test subject to absorb saliva present therein. After a sufficient amount of saliva has been absorbed by the absorber 52, the syringe plunger 50 is extracted from the test subject's mouth and placed into the tube 42 via the opening 48 such that the foam/sponge absorber 52 enters the tube 42 toward the tapered end 46.

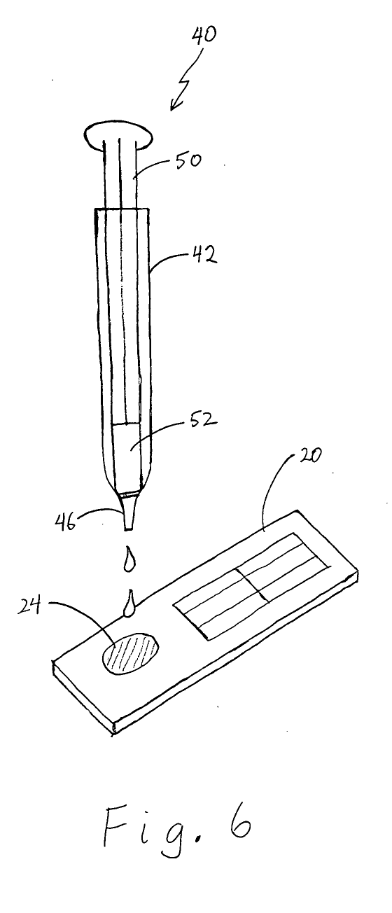

As shown in FIG. 6, by pushing down on the syringe plunger 50 toward the tapered end 44, the foam/sponge absorber 52 is squeezed and compressed such that the saliva sample is forced out of the pores of the absorber 52 and expelled through the dispensing hole 46 located at the tip of the tapered end 44. In one embodiment, the saliva sample is expelled from the opening 46 in droplets which are made to fall into the sample well 24 of the test device 20. Thereafter, the test device 20 may be scanned and analyzed in accordance with the method and system described above.

Various preferred embodiments of the invention have been described above. Although the invention is described in the context of analyzing biological/chemical test devices, the invention may be used in other suitable contexts wherein the analysis of digital images is performed. Accordingly, as used herein, the term “test device” should be construed more broadly than biological and/or chemical test devices. It is intended to encompass any device, test strip, or other media capable of providing useful information by means of digital image analysis. One of ordinary skill in the art will appreciate that the above descriptions of the preferred embodiments are exemplary only and that the invention may be practiced with modifications or variations of the techniques disclosed above. Those of ordinary skill in the art will know, or be able to ascertain using no more than routine experimentation, many equivalents to the specific embodiments of the invention described herein. Such modifications, variations and equivalents are contemplated to be within the spirit and scope of the present invention as set forth in the claims below.

What is claimed is:

1. A system for analyzing test devices, comprising:
a computer for executing digital imaging software;
a scanner, coupled to the computer, for generating digital images; and
a template for holding at least one test device, wherein the template is configured to fit on a scanning surface of said scanner and includes at least one window configured for receiving said at least one test device so as to maintain the at least one test device in a fixed location during scanning of the at least one test device by said scanner.

2. The system of claim 1 wherein said at least one window defines at least one target area for scanning when said template is positioned on said scanner for scanning.

3. The system of claim 1 wherein said scanner is a standard off-the-shelf digital scanner.

4. The system of claim 1 wherein said test device is an immunoassay test device for detecting the presence of one or more target substances in a human fluid and indicating the presence of said one or more target substances by providing a visually observable indicator.

5. The system of claim 1 wherein said scanner generates a digital image of said at least one test device and said computer generates a report containing desired information based on an analysis of the digital image of the at least one test device by said digital imaging software.

6. A template for use in a test device analysis system, comprising:
a sheet of rigid material, wherein said sheet is configured to lay flat on a scanning surface of a digital scanner;
a plurality of windows cut into said sheet, wherein the size and shape of said windows are configured to receive and hold a corresponding test device in a fixed position during scanning of the test device by the digital scanner.

7. The template of claim 6 wherein said plurality of windows further define target areas for analysis when said template is positioned on said scanning surface.

8. A method of analyzing test devices comprising:
placing a template on a scanning surface of a scanner, wherein the template includes at least one window configured to receive and hold a test device therein;
scanning said template using said scanner so as to generate a digital image of said template;
defining at least one target area for scanning based on the location of said at least one window in said template when the template is positioned on the scanning surface;
placing at least one test device into said at least one window;
scanning the at least one test device while it is positioned in said at least one window so as to create a digital image of said at least one test device; and
analyzing the digital image of said at least one test device so as to determine the presence or absence of at least one visual indicator on said at least one test device.

9. The method of claim 8 further comprising generating a report based on whether said at least one visual indicator is determined to be present or absent.

10. A system for analyzing test devices, comprising:
means for executing digital imaging software;
means for scanning test devices and generating digital images; and
means for holding at least one test device so as to maintain the at least one test device in a fixed location during scanning of the at least one test device by said means for scanning.

11. The system of claim 10 further comprising means for defining at least one target area for scanning said at least one test device when it is positioned within said means for holding.

12. The system of claim 10 wherein said means for scanning comprises a standard off-the-shelf digital scanner.

13. The system of claim 10 wherein said test device is an immunoassay test device for detecting the presence of one or more target substances in a human fluid and indicating the presence of said one or more target substances by providing a visually observable indicator.

14. The system of claim 10 wherein said means for scanning generates a digital image of said at least one test device and said means for executing digital imaging software generates a report containing desired information based on an analysis of the digital image of the at least one test device by said digital imaging software.

15. A computer-readable medium containing instructions executable by a computer that when executed perform a method of analyzing test devices, the method comprising:
scanning a template placed on a scanning surface of a scanner so as to generate a digital image of the template, wherein the template includes at least one window configured to receive and hold a test device therein;
defining at least one target area for scanning based on the location of said at least one window in said template when the template is positioned on the scanning surface;
after at least one test device is placed into said at least one window, scanning the at least one test device while it is positioned in said at least one window so as to create a digital image of said at least one test device;
analyzing the digital image of said at least one test device so as to determine the presence or absence of at least one visual indicator on said at least one test device; and
generating a report based on whether said at least one visual characteristic is present or absent.

16. A device for collecting and dispensing fluid, comprising:
a syringe tube having a tapered end and a fluid dispensing hole at the tip of the tapered end, the syringe tube further including a larger hole at an end opposite to the tapered end; and
a syringe plunger configured to be received by said larger hole of the syringe tube, wherein the syringe plunger includes an absorber member attached at one end of the plunger for absorbing said fluid from a predetermined source such that when the syringe plunger is inserted into the syringe tube via the larger hole, the absorber member is compressed by at least a portion of the internal wall of the syringe tube, thereby expelling at least some of the fluid from the absorber member and dispensing the fluid through said dispensing hole.
